(19) United States
(12) Patent Application Publication
(10) Pub. No.: US 2026/0040208 A1
(43) Pub. Date: Feb. 5, 2026

(54) ELECTRONIC DEVICE FOR PERFORMING WIRELESS COMMUNICATIONS, AND OPERATION METHOD THEREOF

(71) Applicant: SAMSUNG ELECTRONICS CO., LTD., Suwon-si (KR)

(72) Inventors: Hyoungkwon KIM, Suwon-si (KR); Naram YOON, Suwon-si (KR); Soyoung YOON, Suwon-si (KR); Kyungwon LEE, Suwon-si (KR); Sanghyun LEE, Suwon-si (KR)

(73) Assignee: SAMSUNG ELECTRONICS CO., LTD., Suwon-si (KR)

(21) Appl. No.: 19/275,353

(22) Filed: Jul. 21, 2025

Related U.S. Application Data
(63) Continuation of application No. PCT/KR2025/010000, filed on Jul. 9, 2025.

(30) Foreign Application Priority Data
Aug. 5, 2024 (KR) 10-2024-0104198
Aug. 27, 2024 (KR) 10-2024-0114882

(51) Int. Cl. H04W 48/20; H04W 8/00; H04W 8/22

(52) U.S. Cl. CPC H04W 48/20; H04W 8/005; H04W 8/22

(57) ABSTRACT

An electronic device includes communication circuitry, one or more processors including processing circuitry, and memory storing instructions. The instructions, when executed by the one or more processors individually or collectively, cause the electronic device to perform a scan related to multiple frequencies included in a frequency list related to cell selection, configure priorities of the multiple frequencies based on a result of the scan, update the priorities of the multiple frequencies based on at least one feature of the electronic device, and perform the cell selection based on the updated priorities of the multiple frequencies.

### CROSS-REFERENCE TO RELATED APPLICATIONS

This application is a continuation application of International Application No. PCT/KR2025/010000, filed on Jul. 9, 2025, which claims priority to Korean Patent Application No. 10-2024-0104198, filed on Aug. 5, 2024, and Korean Patent Application No. 10-2024-0114882, filed on Aug. 27, 2024, in the Korean Intellectual Property Office, the disclosures of which are incorporated by reference herein in their entireties.

### BACKGROUND

### 1. Field

The disclosure relates to an electronic device for wireless communications and an operation method thereof.

### 2. Description of Related Art

To meet the demand for wireless data traffic having increased since deployment of 4th generation (4G) communication systems, efforts have been made to develop a 5th generation (5G) communication system. For example, the 5G communication system may also be referred to as a “beyond 4G network” communication system or a “post long-term evolution (LTE)” system. The 5G communication system may be implemented in 6 gigahertz (GHz) or lower bands (e.g., about 3.5 GHz bands) and/or higher frequency bands (e.g., about 28 GHz bands or about 39 GHz bands), to provide a higher data throughput. In an attempt to decrease propagation loss of the radio waves and/or increase the transmission distance of radio waves in these frequency bands, beamforming, massive multiple-input multiple-output (MIMO), full dimensional MIMO (FD-MIMO), array antennas, analog beamforming, and/or large scale antenna techniques may be under discussion for use in the 5G communication systems.

The above information may be presented as related art for the purpose of assisting in understanding the disclosure. None of the foregoing may be asserted as prior art relevant to the disclosure or used for determination on prior art.

### SUMMARY

An electronic device (e.g., a user equipment (UE)) in a wireless communication system may, when a communication function is activated, be connected to a specific cell to perform wireless communications. For example, the electronic device may select a cell for the electronic device to be connected through cell selection based on frequencies (e.g., from a stored list of frequencies) to which the electronic device has been connected.

The electronic device may select a cell with priority, in which the electronic device may perform relatively fast wireless communications on frequencies (e.g., stored lists) that may have a history of connection by the electronic device. In case that as the functions required by an electronic device vary to satisfy the diverse needs of users, the electronic device may select a cell with priority, which may provide relative fast wireless communications, the electronic device may be connected to a cell that may be incompatible with the usage purpose of the electronic device.

One or more example embodiments of the present disclosure provide a device and a method for preferentially selecting a cell corresponding to a feature of an electronic device in the electronic device.

The technical subjects pursued in the present disclosure may not be limited to the above-mentioned technical subjects, and other technical subjects which may not be mentioned may be clearly understood from the following descriptions by those skilled in the art to which the present disclosure pertains.

According to an aspect of the present disclosure, an electronic device includes communication circuitry, one or more processors including processing circuitry, and memory storing instructions. The instructions, when executed by the one or more processors individually or collectively, cause the electronic device to perform a scan related to multiple frequencies included in a frequency list related to cell selection, configure priorities of the multiple frequencies based on a result of the scan, update the priorities of the multiple frequencies based on at least one feature of the electronic device, and perform the cell selection based on the updated priorities of the multiple frequencies.

According to an aspect of the present disclosure, an operation method of an electronic device includes performing a scan related to multiple frequencies included in a frequency list related to cell selection, configuring priorities of the multiple frequencies, based on a result of the scan, updating the priorities of the multiple frequencies, based on at least one feature of the electronic device, and performing the cell selection, based on the updated priorities of the multiple frequencies.

According to an aspect of the present disclosure, a non-transitory computer-readable storage medium stores computer-executable instructions for operating an electronic device. The computer-executable instructions, when executed by at least one processor of the electronic device, cause the electronic device to perform a scan related to multiple frequencies included in a frequency list related to cell selection, configure priorities of the multiple frequencies based on a result of the scan, update the priorities of the multiple frequencies based on at least one feature of the electronic device, and perform the cell selection based on the updated priorities of the multiple frequencies.

According to an embodiment, by updating a priority of a frequency list related to cell selection based on a feature of an electronic device in the electronic device, a cell corresponding to a usage purpose of the electronic device may be preferentially selected.

Various other effects understood directly or indirectly through the disclosure may be provided.

Advantageous effects obtainable from the disclosure may not be limited to the above-mentioned effects, and other effects which may not be mentioned may be clearly understood from the following descriptions by those skilled in the art to which the disclosure pertains.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 is a block diagram of an electronic device in a network environment, according to an embodiment;

FIG. 2 is a block diagram illustrating an electronic device for wireless communications, according to an embodiment;

FIG. 3 is a flowchart illustrating updating a priority of a frequency list related to cell selection in an electronic device, according to an embodiment;

FIG. 4 is a flowchart illustrating a scan in an electronic device, according to an embodiment;

FIG. 5 is a flowchart illustrating updating a priority of a frequency list related to cell selection based on a feature of an electronic device in the electronic device, according to an embodiment;

FIG. 6 is a flowchart illustrating updating a priority of a frequency list related to cell selection based on a feature of an electronic device in the electronic device, according to an embodiment; and

FIG. 7 is a flowchart illustrating adding at least one frequency to a frequency list related to cell selection in an electronic device, according to an embodiment.

### DETAILED DESCRIPTION

The following description with reference to the accompanying drawings is provided to assist in a comprehensive understanding of embodiments of the present disclosure defined by the claims and their equivalents. Various specific details are included to assist in understanding, but these details are considered to be exemplary only. Therefore, those of ordinary skill in the art may recognize that various changes and modifications of the embodiments described herein may be made without departing from the scope and spirit of the disclosure. In addition, descriptions of well-known functions and structures are omitted for clarity and conciseness.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, or the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings.

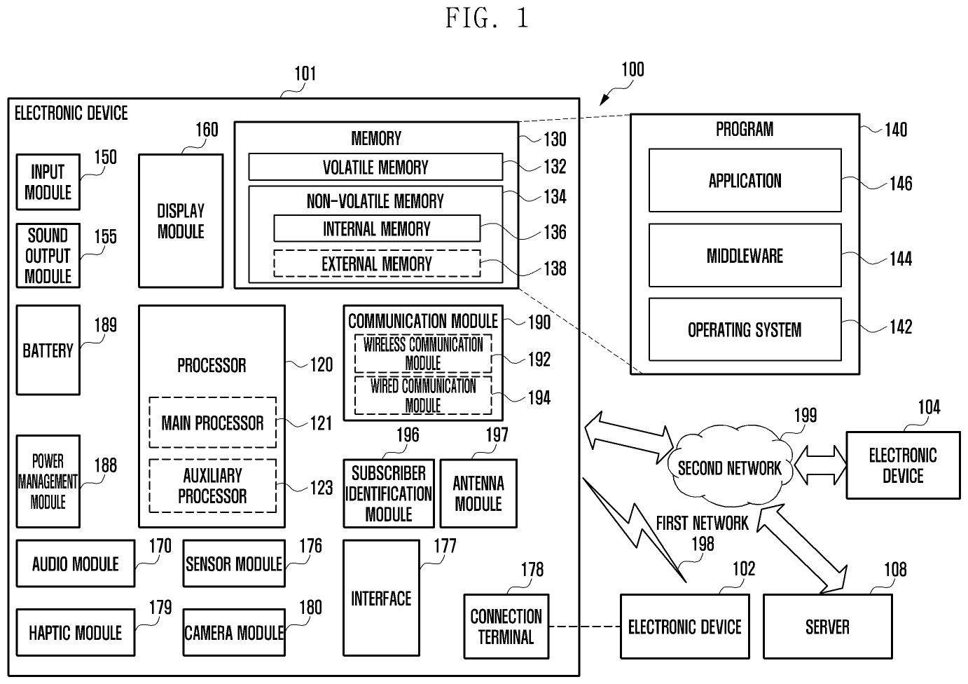

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC. According to an embodiment, the subscriber identification module 196 may include a plurality of subscriber identification modules. For example, the plurality of subscriber identification modules store different subscriber identification information.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band. For example, the plurality of antennas include patch array antenna and/or dipole antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

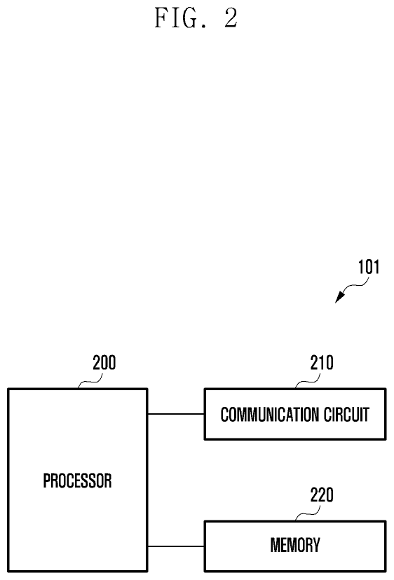

FIG. 2 is a block diagram illustrating an electronic device for wireless communications, according to an embodiment. For example, the electronic device 101 in FIG. 2 may be at least partially similar to the electronic device 101 in FIG. 1 or may further include other embodiments of the electronic device.

According to an embodiment referring to FIG. 2, the electronic device 101 may include at least one of a processor 200, a communication circuit (or communication circuitry) 210, and memory 220. According to an embodiment, the processor 200 may be substantially similar and/or the same as the processor 120 (e.g., a communication processor) in FIG. 1 and/or may be included in the processor 120. The communication circuit 210 may be substantially similar and/or the same as the wireless communication module 192 in FIG. 1 and/or may be included in the wireless communication module 192. The memory 220 may be substantially similar and/or the same as the memory 130 in FIG. 1 and/or may be included in the memory 130. For example, the processor 200 may be operatively, functionally, and/or electrically connected to at least one of the communication circuit 210 or the memory 220. For example, the processor 200 may include at least one processor including a processing circuitry.

According to an embodiment, the processor 200 may, in a case that occurrence of an event related to cell selection is detected, identify whether a frequency list related to cell selection exists in the memory 220. For example, a state where the event related to cell selection occurs may include at least one of a state where the communication circuit 210 having been deactivated is activated, a state where it is determined that the electronic device 101 is out of a shaded (e.g., out of range, blocked, or the like) area, or a state where communication restrictions (e.g., airplane mode) of the electronic device 101 are released. For example, the frequency list related to cell selection may include information related to at least one frequency for preferentially performing a scan for cell selection of the electronic device 101. As another example, the frequency list related to cell selection may include at least one frequency in which a connection history of the electronic device 101 exists and a cell parameter related to each frequency. For example, the cell parameter may include the configuration information for a cell identified in a system information (e.g., system information block (SIB)) for a cell that may support the corresponding frequency.

According to an embodiment, the processor 200 may, in a case that the frequency list related to cell selection exists in the memory 220, control the communication circuit 210 to perform a scan (e.g., a power scan) related to at least one frequency included in the frequency list related to cell selection. By way of example, the processor 200 may identify channel state information of each frequency included in the frequency list related to cell selection through a scan (e.g., a power scan) related to the frequency. For example, the channel state information may include at least one of a received signal strength indication (RSSI), a reference signal received quality (RSRQ), a reference signal received power (RSRP), a signal to noise ratio (SNR), a signal to interference and noise ratio (SINR), a quality of service (QoS), a block error rate (BLER), a modulation and coding scheme (MCS), a bit error rate (BER), or the like.

According to an embodiment, the processor 200 may configure priorities of frequencies included in the frequency list related to cell selection based on a result of the scan related to the frequency. By way of example, the processor 200 may configure a relatively high priority for a frequency with relatively high (or good) channel state information.

According to an embodiment, the processor 200 may update the priorities of frequencies included in the frequency list related to cell selection based on a feature of the electronic device 101. For example, the feature of the electronic device 101 may include a performance required by a function (or service or use purpose) provided by the electronic device 101. As another example, the feature of the electronic device 101 may be configured based on at least one of an execution history of an application program of the electronic device 101, an application program running in the electronic device 101, a capability (e.g., a UE capability) of the electronic device 101.

For example, the processor 200 may identify (or select) at least one frequency for updating the priority based on at least one feature of the electronic device 101 from among frequencies included in the frequency list related to cell selection. By way of example, the at least one frequency for updating the priority may include a frequency of which channel state information satisfies a designated first condition based on the result of the scan related to the frequency of which channel state information exceeds a designated reference value.

By way of example, the processor 200 may, in a case that the electronic device 101 includes multiple features, sequentially update the priorities of frequencies included in the frequency list related to cell selection based on respective features. For example, the updating of the priority may include a series of operations for updating the priority of at least one frequency identified (or selected) based on the result of a scan related to the frequency from among the frequencies included in the frequency list related to cell selection.

By way of example, the processor 200 may update the priorities of frequencies included in the frequency list related to cell selection based on a weight configured by at least one feature of the electronic device 101. For example, the updating of the priority may include a series of operations for updating, based on a sum of weights, the priority of at least one frequency identified (or selected) based on the result of a scan related to the frequency from among the frequencies included in the frequency list related to cell selection.

According to an embodiment, the processor 200 may control the communication circuit 210 to perform cell selection by using the frequency list related to the cell selection having the updated priority based on a feature of the electronic device 101. For example, the processor 200 may identify whether a cell for camping on (or camp on) exists by sequentially using each frequency, based on the priorities of frequencies included in the frequency list related to cell selection. As another example, the camping on may include a series of operations of identifying whether there is a cell to which the electronic device 101 may be connected (or registered), based on at least one of channel state information for a cell using a designated frequency, a list of cells that are prohibited from registering, or a service provider of a cell.

By way of example, the processor 200 may control the communication circuit 210 to identify whether there is a cell for camping on by using a frequency having a highest priority in the frequency list which is related to cell selection and of which priority has been updated based on a feature of the electronic device 101. The processor 200 may, in a case of identifying that there is a cell for camping on (or a cell suitable for camping on) by using the frequency having the highest priority, identify (or select) the corresponding cell as a cell to which the electronic device 101 may be connected (or registered). The processor 200 may, in a case of identifying that there is no cell for camping on (or no cell suitable for camping on) by using the frequency having the highest priority, control the communication circuit 210 to identify whether there is a cell for camping on by using a frequency having a next priority.

For example, the processor 200 may, in a case that the cell selection using frequencies included in the frequency list related to cell selection has failed, control the communication circuit 210 to perform cell selection using frequencies included in the frequency list related to cell selection. The processor 200 may, in a case that cell selection using frequencies included in the frequency list related to cell selection fails a specified number of times, control the communication circuit 210 to perform a scan (e.g., a full scan) related to a frequency (or frequency band) supported by the electronic device 101. By way of example, the failure in cell selection may include a state where a cell for camping on of the electronic device 101 is not detected by using frequencies included in the frequency list related to cell selection.

According to an embodiment, the processor 200 may, in a case that a cell to which the electronic device 101 may be connected is selected by using frequencies included in the frequency list related to cell selection, update the frequency list related to cell selection, based on system information of the corresponding cell. For example, the processor 200 may identify (or obtain) additional frequency information from the system information (e.g., SIB 4) received from the cell to which the electronic device 101 may be connected and which is selected using the frequency list related to cell selection. The processor 200 may add the additional frequency information to the frequency list related to cell selection. For example, the additional frequency information may be added to the frequency list related to cell selection with a relatively low priority. For example, the additional frequency information may include information related to a frequency (e.g., an inter frequency) of a neighboring cell different from the cell to which the electronic device 101 may be connected and which is selected using the frequency list related to cell selection.

According to an embodiment, the processor 200 may, in a case that there is no frequency list related to cell selection in the memory 220, control the communication circuit 210 to perform a scan (e.g., a full scan) related to a frequency (or frequency band) supported by the electronic device 101. The processor 200 may perform cell selection based on a result of the scan (e.g., a full scan) related to a frequency (or frequency band) supported by the electronic device 101.

According to an embodiment, the communication circuit 210 may support wireless communications between the electronic device 101 and an external electronic device (e.g., a base station, the electronic device 102 or 104, or the server 108). For example, the wireless communications may include cellular communications (e.g., long term evolution (LTE) and/or new radio (NR)).

According to an embodiment, the memory 220 may store various data used by at least one component (e.g., the processor 200 or the communication circuit 210) of electronic device 101. For example, the memory 220 may store various instructions executable through the processor 200. By way of example, the instructions may be executed by the processor 200 (e.g., at least one processor) individually or collectively.

According to an embodiment, the electronic device 101 may configure priorities of frequencies included in the frequency list related to cell selection based on a feature of the electronic device 101. For example, the electronic device 101 may omit a scan (e.g., a power scan) related to at least one frequency included in the frequency list related to cell selection.

According to an embodiment, an electronic device (e.g., the electronic device 101) may include a communication circuit (e.g., the wireless communication module 192 or the communication circuit 210), at least one processor (e.g., the processor 120 or the processor 200), and memory (e.g., the memory 130 or the memory 220). According to an embodiment, the memory may store instructions which, when executed by the at least one processor individually or collectively, may cause the electronic device to perform a scan related to multiple frequencies included in a frequency list related to cell selection. According to an embodiment, the memory may store instructions which, when executed by the at least one processor individually or collectively, may further cause the electronic device to configure priorities of the multiple frequencies, based on a result of the scan. According to an embodiment, the memory may store instructions which, when executed by the at least one processor individually or collectively, may further cause the electronic device to update the priorities of the multiple frequencies included in the frequency list, based on at least one feature of the electronic device. According to an embodiment, the memory may store instructions which, when executed by the at least one processor individually or collectively, may further cause the electronic device to perform cell selection, based on the updated priorities of the multiple frequencies included in the frequency list.

According to an embodiment, the memory may store instructions which, when executed by the at least one processor individually or collectively, may further cause the electronic device to identify at least one feature of the electronic device, based on at least one of an execution history of an application program of the electronic device, an application program running in the electronic device, or a capability of the electronic device.

According to an embodiment, the at least one feature of the electronic device may include at least one of a function related to a reduced capability (RedCap), a power reduction function, a high reliability, a high transfer rate, or a service area.

According to an embodiment, the instructions may include instructions which, when executed by the at least one processor individually or collectively, may further cause the electronic device to configure a relatively high priority for frequency with relatively high channel state information, based on a result of the scan.

According to an embodiment, the instructions may include instructions which, when executed by the at least one processor individually or collectively, may further cause the electronic device to identify at least one frequency for updating the priority from among the multiple frequencies included in the frequency list based on the result of the scan. According to an embodiment, the instructions may include instructions which, when executed by the at least one processor individually or collectively, may further cause the electronic device to update the priority of at least one frequency included in the frequency list, based on at least one feature of the electronic device.

According to an embodiment, the instructions may include instructions which, when executed by the at least one processor individually or collectively, may further cause the electronic device to, in a case that multiple features are considered, sequentially update the priorities of the multiple frequencies included in the frequency list, based on respective features of the electronic device.

According to an embodiment, the instructions may include instructions which, when executed by the at least one processor individually or collectively, may further cause the electronic device to identify a weight for each of the multiple frequencies included in the frequency list, based on respective features of the electronic device. According to an embodiment, the instructions may include instructions which, when executed by the at least one processor individually or collectively, may further cause the electronic device to update the priorities of the multiple frequencies included in the frequency list, based on the sum of weights.

According to an embodiment, the instructions may include instructions which, when executed by the at least one processor individually or collectively, may further cause the electronic device to sequentially perform cell selection using each frequency included in the frequency list based on the updated priority.

According to an embodiment, the memory may store instructions which, when executed by the at least one processor individually or collectively, may further cause the electronic device to obtain additional frequency information based on system information obtained from a cell selected for cell selection. According to an embodiment, the memory may store instructions which, when executed by the at least one processor individually or collectively, may further cause the electronic device to add the additional frequency information to the frequency list with a relatively low priority.

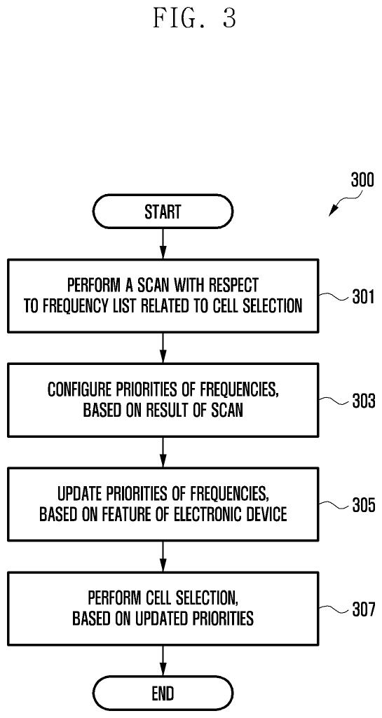

FIG. 3 is a flowchart 300 illustrating updating a priority of a frequency list related to cell selection in an electronic device, according to an embodiment. In the following embodiment, respective operations may be sequentially performed, but are not necessarily sequentially performed. For example, the sequential position of each operation may be changed, or at least two operations may be performed in parallel. By way of example, the electronic device In FIG. 3 may correspond to the electronic device 101.

According to an embodiment referring to FIG. 3, the electronic device (e.g., the electronic device 101) or a processor (e.g., the processor 120 or the processor 200) may perform, in operation 301, a scan (or searching) with respect to a frequency list related to cell selection. For example, the processor 200 may, in a case that occurrence of an event related to cell selection is detected, identify whether there is a frequency list related to cell selection in the memory 220. For example, a state where the event related to cell selection occurs may include, but not be limited to, at least one of a state where the communication circuit 210 having been deactivated is activated, a state where it is determined that the electronic device 101 is out of a shaded (e.g., out of range, blocked, or the like) area, or a state where communication restrictions (e.g., airplane mode) of the electronic device 101 are released. For example, the frequency list related to cell selection may include information related to at least one frequency for preferentially performing a scan for cell selection of the electronic device 101. As another example, the frequency list related to cell selection may include at least one frequency in which a connection history of the electronic device 101 exists and a cell parameter related to each frequency as shown in Table 1.

TABLE 1

| Frequency | Cell Parameter |
|---|---|
| A | No intraFreqReselectionRedCap-r17 IE |
| B | All capability is supported |
| | intraFreqReselectionRedCap-r17 IE (not supported) |
| | SCS 30 kHz, BW 50 MHz |
| C | only cellbarredRedCap1Rx-r17 (supported) |
| | intraFreqReselectionRedCap-r17 IE (supported) |
| | SCS 30 kHz, BW 50 MHz |
| | power saving (supported) |
| D | only cellbarredRedCap1Rx/2Rx-r17 (supported) |
| | intraFreqReselectionRedCap-r17 IE (supported) |
| | SCS 30 kHz, BW 50 MHz |
| E | All capability is supported |
| | intraFreqReselectionRedCap-r17 IE (supported) |
| | SCS 120 kHz, BW 100 MHz |
| | power saving (supported) |

For example, the cell parameter may include the configuration information for a cell identified in a system information (e.g., SIB) for a cell that supports the corresponding frequency as shown in Table 2.

TABLE 2

| Classification | Item |
|---|---|
| capability | halfDuplexRedCap-Allowed-r17 (SIB 1) |
| | cellBarredRedCap1Rx-r17 (SIB 1) |
| | cellBarredRedCap2Rx-r17 (SIB 1) |
| | intraFreqReselectionRedCap-r17 (SIB 1) |
| coverage | intraFreqReselectionRedCap-r17 (SIB 1) |
| power saving | eDRX-Allowedidle-r17 (SIB1) |
| | relaxedMeasurement-r16 (SIB 2) |
| | UAI power saving (RRC reconfiguration) |
| | CDRX (RRC reconfiguration) |
| | CDRX longDrxCycleLength |
| | (RRC reconfiguration) |
| URLLC/eMBB | subcarrierspacing (SIB 1) |
| | bandwidth (carrierBandwidth) |
| | modulation |
| | PDCP duplication (RRC reconfiguration) |
| | Configured grant (RRC reconfiguration) |
| | Mini-slot (RRC reconfiguration) |

For example, whether a function related to the reduced capability (RedCap) is supported may be identified based on at least one of “halfDuplexRedCap-Allowed”, “cellBarredRedCap1Rx”, “cellBarredRedCap2Rx” or “intraFreqReselectionRedCap” identified in SIB 1. As another example, the service area (e.g., a coverage) may be identified based on “intraFreqReselectionRedCap” identified from SIB 1. By way of example, whether the power reduction function is supported may be identified based on at least one of “eDRX-Allowedidle” identified from SIB 1 or “relaxedMeasurement” identified from SIB 2. For example, whether the power reduction function is supported may be identified based on at least one of “UAI power saving”, “CDRX (connected mode DRX (discontinuous reception))” or “CDRX longDrxCycleLength” identified through a radio resource control (RRC) message (e.g., RRC configuration) related to RRC connection. As another example, whether the high reliability (e.g., enhanced mobile broadband (eMBB)) is supported may be identified based on at least one of a bandwidth, a modulation, or subcarrierspacing (SCS). As another example, whether the high reliability (e.g., ultra reliable and low latency communication (URLLC)) is supported may be identified based on at least one of whether a packet data convergence protocol (PDCP) duplication is used, whether Configured Grant is used, or whether a mini slot is configured, identified through the RRC message (e.g., RRC reconfiguration) related to the RRC connection.

For example, the processor 200 may, in a case that the frequency list related to cell selection exists in the memory 220, control the communication circuit 210 to perform a scan (e.g., a power scan) related to at least one frequency included in the frequency list related to cell selection. By way of example, the scan (e.g., a power scan) related to the frequency may include a series of operations of identifying channel state information of each frequency included in the frequency list related to cell selection. For example, the channel state information may include at least one of RSSI, RSRQ, RSRP, SNR, SINR, QoS, BLER, MCS, BER, or the like.

According to an embodiment, the electronic device (e.g., the electronic device 101) or the processor (e.g., the processor 120 or 200) may, in operation 303, configure priorities of frequencies included in the frequency list related to cell selection based on a result of the scan with respect to the frequency list related to cell selection. By way of example, the processor 200 may configure a relatively high priority for a frequency with relatively high (or good) channel state information.

According to an embodiment, the electronic device (e.g., the electronic device 101) or the processor (e.g., the processor 120 or 200) may, in operation 305, update the priorities of frequencies included in the frequency list related to cell selection based on at least one feature of the electronic device 101. For example, the feature of the electronic device 101 may include a performance required by a function (or service) provided by the electronic device 101 as shown in Table 3. As another example, the feature of the electronic device 101 may be configured based on at least one of an execution history of an application program of the electronic device 101, an application program running in the electronic device 101, a capability (e.g., a UE capability) of the electronic device 101.

TABLE 3

| Type of electronic device | Features of electronic device |
|---|---|
| redcap VR | redcap capability, URLLC/eMBB, coverage |
| VR | URLLC/eMBB, coverage |
| Fixed sensor | redcap capability, power saving |
| redcap watch | redcap capability, coverage, eMBB |
| | redcap capability, coverage, power saving |
| watch | coverage, eMBB |
| | coverage, power saving |

For example, the feature of the electronic device 101 may, in a case that the electronic device 101 corresponds to a virtual reality (VR) device or an augmented reality (AR) device supporting the reduced capability (RedCap), include at least one of the reduced capability, the high reliability, the high transfer rate, or the service area. As another example, the feature of the electronic device 101 may, in a case that the electronic device 101 corresponds to a VR device, include at least one of the high reliability, the high transfer rate, or the service area. As another example, the feature of the electronic device 101 may, in a case that the electronic device 101 corresponds to a fixed sensor (or fixed sensor device), include at least one of the reduced capability, or the power reduction. As another example, the feature of the electronic device 101 may, in a case that the electronic device 101 corresponds to a wearable device (e.g., a watch, glasses, or the like) in a first state supporting the reduced capability include at least one of the reduced capability, the high reliability, or the service area. As another example, the feature of the electronic device 101 may, in a case that the electronic device 101 corresponds to a wearable device (e.g., a watch, glasses, or the like) in a second state supporting the reduced capability, include at least one of the reduced capability, the high reliability, or the power reduction. As another example, the feature of the electronic device 101 may, in a case that the electronic device 101 corresponds to a wearable device (e.g., a watch, glasses, or the like) in the first state, include at least one of the high reliability or the service area. For example, the feature of the electronic device 101 may, in a case that the electronic device 101 corresponds to a wearable device (e.g., a watch, glasses, or the like) in the second state, include at least one of the high reliability or the power reduction. By way of example, the first state may include a state where a remaining battery capacity of the electronic device 101 exceeds a designated reference remaining capacity. By way of example, the second state may include a state where a remaining battery capacity of the electronic device 101 is less than or equal to the designated reference remaining capacity.

In an embodiment, the processor 200 may update the priorities of frequencies included in the frequency list related to cell selection based on respective features, based on at least one feature of the electronic device 101.

For example, the processor 200 may identify (or select) at least one frequency for updating the priority based on at least one feature of the electronic device 101 from among frequencies included in the frequency list related to cell selection. By way of example, the at least one frequency for updating the priority may include a frequency of which channel state information satisfies a designated first condition based on the result of the scan related to the frequency of which channel state information exceeds a designated reference value.

By way of example, the processor 200 may sequentially update priorities of frequencies included in the frequency list related to cell selection based on respective features of the electronic device 101. For example, the updating of the priority may include a series of operations for updating the priority of at least one frequency identified (or selected) based on the result of a scan related to the frequency from among the frequencies included in the frequency list related to cell selection.

In an embodiment, the processor 200 may update the priorities of frequencies included in the frequency list related to cell selection based on a weight configured by at least one feature of the electronic device 101. For example, the updating of the priority may include a series of operations for updating, based on a sum of weights, the priority of at least one frequency identified (or selected) based on the result of a scan related to the frequency from among the frequencies included in the frequency list related to cell selection.

According to an embodiment, the electronic device (e.g., the electronic device 101) or the processor (e.g., the processor 120 or 200) may, in operation 307, perform cell selection by using the frequency list related to the cell selection having the updated priority based on a feature of the electronic device 101. For example, the processor 200 may identify whether a cell for camping on exists by sequentially using each frequency, based on the priorities of frequencies included in the frequency list related to cell selection. As another example, the camping on may include a series of operations of identifying whether there is a cell to which the electronic device 101 may be connected, based on at least one of channel state information for a cell using a designated frequency, a list of cells that are prohibited from registering, or a service provider of a cell.

By way of example, the processor 200 may control the communication circuit 210 to identify whether there is a cell for camping on by using a frequency having a highest priority in the frequency list which is related to cell selection and of which priority has been updated based on a feature of the electronic device 101. The processor 200 may, in a case of identifying that there is a cell for camping on (or a cell suitable for camping on) by using the frequency having the highest priority, identify (or select) the corresponding cell as a cell to which the electronic device 101 may be connected (or registered). The processor 200 may, in a case of identifying that there is no cell for camping on (or no cell suitable for camping on) by using the frequency having the highest priority, control the communication circuit 210 to identify whether there is a cell for camping on by using a frequency having a next priority.

According to an embodiment, the electronic device 101 may, in a case that the cell selection using frequencies included in the frequency list related to cell selection has failed, perform cell selection using frequencies included in the frequency list related to cell selection. For example, the processor 200 may, in a case the cell selection using frequencies included in the frequency list related to cell selection has failed, control the communication circuit 210 to perform cell selection repeatedly a designated number of times by using frequencies included in the frequency list related to cell selection. The processor 200 may, in a case that cell selection using frequencies included in the frequency list related to cell selection fails a specified number of times, control the communication circuit 210 to perform a scan (e.g., a full scan) related to a frequency (or frequency band) supported by the electronic device 101. By way of example, the failure in cell selection may include a state where a cell for camping on of the electronic device 101 is not detected by using frequencies included in the frequency list related to cell selection.

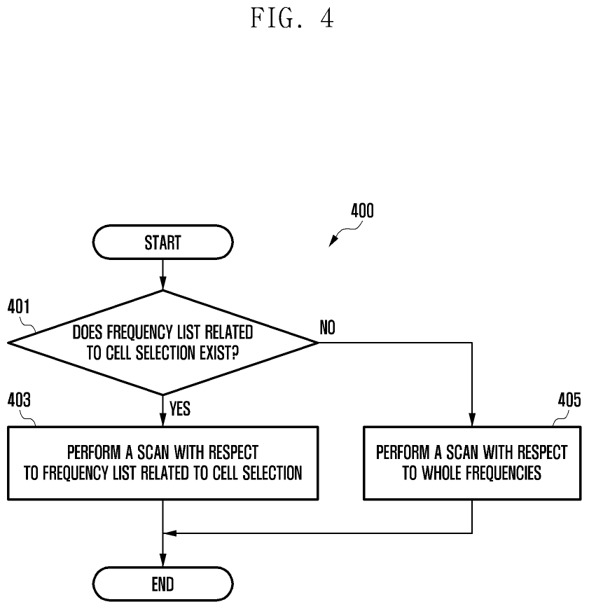

FIG. 4 is a flowchart 400 illustrating a scan in an electronic device, according to an embodiment. By way of example, at least a portion of FIG. 4 may include a detailed operation of operation 301. In the following embodiment, respective operations may be sequentially performed, but are not necessarily sequentially performed. For example, the sequential position of each operation may be changed, or at least two operations may be performed in parallel. By way of example, the electronic device in FIG. 4 may correspond to the electronic device 101.

According to an embodiment referring to FIG. 4, the electronic device (e.g., the electronic device 101) or the processor (e.g., the processor 120 or the processor 200) may identify, in operation 401, whether there is a frequency list related to cell selection. For example, the processor 200 may, in a case that occurrence of an event related to cell selection is detected, identify whether there is a frequency list related to cell selection in the memory 220. As another example, a state where the event related to cell selection occurs may include at least one of a state where the communication circuit 210 having been deactivated is activated, a state where it is determined that the electronic device 101 is out of a shaded (e.g., out of range, blocked, or the like) area, or a state where communication restrictions (e.g., an airplane mode) of the electronic device 101 are released.

According to an embodiment, the electronic device (e.g., the electronic device 101) or the processor (e.g., the processor 120 or 200) may, in a case that the frequency list related to cell selection exists (e.g., “Yes” in operation 401), perform, in operation 403, a scan (e.g., a power scan) with respect to the frequency list related to cell selection. For example, the processor 200 may, in a case that the frequency list related to cell selection exists in the memory 220, identify channel state information of each frequency included in the frequency list related to cell selection through a scan (e.g., a power scan) related to at least one frequency included in the frequency list related to cell selection. As another example, the processor 200 may configure priorities of frequencies included in the frequency list related to cell selection based on a result of the scan with respect to the frequency list related to cell selection.

According to an embodiment, the electronic device (e.g., the electronic device 101) or the processor (e.g., the processor 120 or 200) may, in a case that there is no frequency list related to cell selection (e.g., “No” in operation 401), perform, in operation 405, cell selection based on a result of the scan related to a frequency (or frequency band) supported by the electronic device 101. By way of example, the processor 200 may, in a case that there is no frequency list related to cell selection in the memory 220, control the communication circuit 210 to perform a scan (e.g., a full scan) related to a frequency (or frequency band) supported by the electronic device 101. The processor 200 may perform cell selection based on a result of the scan (e.g., a full scan) related to a frequency (or frequency band) supported by the electronic device 101.

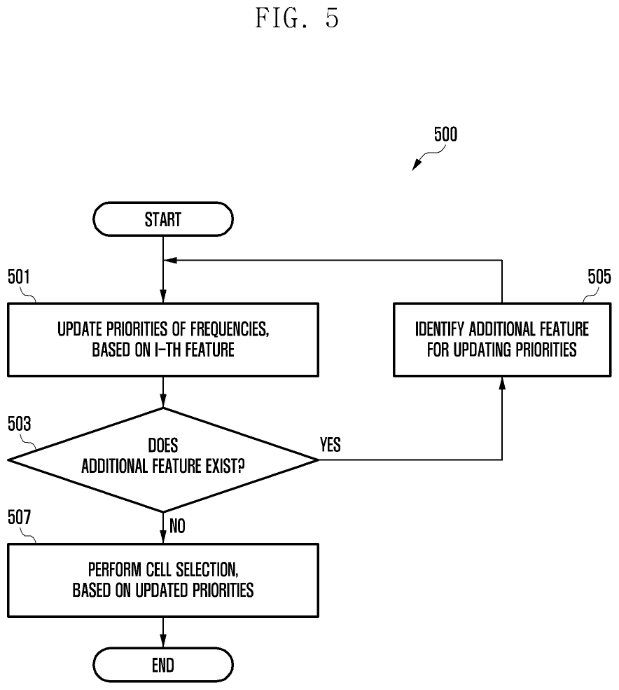

FIG. 5 is a flowchart 500 illustrating updating a priority of a frequency list related to cell selection based on a feature of an electronic device in the electronic device, according to an embodiment. By way of example, at least a portion of FIG. 5 may include a detailed operation of operation 305 and operation 307. In the following embodiment, respective operations may be sequentially performed, but are not necessarily sequentially performed. For example, the sequential position of each operation may be changed, or at least two operations may be performed in parallel. By way of example, the electronic device in FIG. 5 may correspond to the electronic device 101.

According to an embodiment referring to FIG. 5, the electronic device (e.g., the electronic device 101) or the processor (e.g., the processor 120 or the processor 200) may, in a case that the priorities of frequencies included in the frequency list related to cell selection have been configured based on the result of the scan with respect to the frequency list related to cell selection (e.g., operation 303), update, in operation 501, the priorities of frequencies included in the frequency list related to cell selection based on an i-th feature of the electronic device 101. For example, the processor 200 may configure priorities of the frequencies (e.g., a first frequency A, a second frequency B, a third frequency C, a fourth frequency D, and a fifth frequency E) included in the frequency list related to cell selection configured as shown in Table 1 as “A→B→C→D→E” based on the result of the scan with respect to the frequency list related to cell selection. As another example, “A→B→C→D→E” may indicate that frequency A has the highest priority and frequency E has the lowest priority.

By way of example, the processor 200 may, in a case that the electronic device 101 corresponds to a VR device (or an AR device) supporting the reduced capability, identify the reduced capability, the high reliability, the high transfer rate, and the service area as the feature of the electronic device 101. The processor 200 may update the priorities of frequencies included in the frequency list related to cell selection to “B→D→E→C→A”, based on the reduced capability from among features of the electronic device 101. For example, the processor 200 may, in a case that the electronic device 101 supports two (2) receive paths (Rx), update the priority of frequency C, which support the reduced capability and support one receive path, to have a priority lower than that of frequency B, frequency D, and frequency E which support the reduced capability and two receive paths. For example, a frequency supporting the reduced capability and two receive paths may have “cellBarredRedCap2Rx” configured to “not barred.” As another example, a frequency supporting the reduced capability and one receive path may have “cellBarredRedCap1Rx” configured to “not barred.” As another example, a frequency not supporting the reduced capability may have “cellBarredRedCap2Rx” or “cellBarredRedCap1Rx” configured to “barred.”

For example, the processor 200 may, in a case that frequency A in the frequency list related to cell selection configured as shown in Table 1 does not support the reduced capability, update the priority of frequency A to have the lowest priority. As another example, the processor may delete frequency A not supporting the reduced capability from the frequency list related to cell selection.

According to an embodiment, the electronic device (e.g., the electronic device 101) or the processor (e.g., the processor 120 or 200) may, in operation 503, identify whether there is an additional feature not used for updating the priorities of frequencies included in the frequency list related to cell selection, from among features of the electronic device 101. For example, the processor 200 may identify whether there is a feature not used for updating the priorities of frequencies included in the frequency list related to cell selection, from among the reduced capability, the high reliability, the high transfer rate, and the service area, corresponding to a VR device (or AR device) supporting the reduced capability.

According to an embodiment, the electronic device (e.g., the electronic device 101) or the processor (e.g., the processor 120 or 200) may, in a case that there is the additional feature not used for updating the priorities of frequencies included in the frequency list related to cell selection (e.g., “Yes” in operation 503), identify, in operation 505, an additional feature to be considered to update the priorities of frequencies included in the frequency list related to cell selection. For example, the processor 200 may identify features of the reduced capability, the high reliability, the high transfer rate, and the service area corresponding to a VR device (or AR device) supporting the reduced capability as the additional feature.

According to an embodiment, the electronic device (e.g., the electronic device 101) or the processor (e.g., the processor 120 or 200) may, in operation 501, update the priorities of frequencies of the frequency list related to cell selection based on the additional feature (e.g., a (i+1)-th feature) of the electronic device 101. For example, the processor 200 may update the priorities of frequencies of the frequency list related to cell selection to “E→B→D→C→A” based on the high reliability and the high transfer rate. By way of example, the processor 200 may update the priority of frequency E supporting a highest SCS to the highest priority.

According to an embodiment, the electronic device (e.g., the electronic device 101) or the processor (e.g., the processor 120 or 200) may repeatedly perform operations 501 to 505 until the priorities of the frequencies included in the frequency list related to cell selection are updated by considering all features of the electronic device 101. For example, the processor 200 may update the priorities of frequencies of the frequency list related to cell selection to “E→D→B→C→A” based on a service area state. By way of example, the processor 200 may update frequency D supporting “intraFreqReselectionRedCap” to have a priority higher than that of frequency B supporting “intraFreqReselectionRedCap.” For example, a state of supporting “intraFreqReselectionRedCap” may include a state of being able to support a relatively large service area.

According to an embodiment, the electronic device (e.g., the electronic device 101) or the processor (e.g., the processor 120 or 200) may, in a case that there is no additional feature not used for updating the priorities of frequencies included in the frequency list related to cell selection (e.g., “No” in operation 503), perform, in operation 507, cell selection by using the frequency list related to the cell selection having the updated priority based on a feature of the electronic device 101. By way of example, the processor 200 may control the communication circuit 210 to identify whether there is a cell for camping on by using frequency E having a highest priority in the frequency list which is related to cell selection and of which priority has been updated based on a feature of the electronic device 101. The processor 200 may, in a case of identifying that there is a cell for camping on (or a cell suitable for camping on) by using frequency E, identify (or select) the corresponding cell as a cell to which the electronic device 101 may be connected (or registered). The processor 200 may, in a case of identifying that there is no cell for camping on (or no cell suitable for camping on) by using frequency E, control the communication circuit 210 to identify whether there is a cell for camping on by using a frequency having a next priority D.

According to an embodiment, the electronic device 101 may, in a case that there is no cell using frequency E and frequency D for camping on of the electronic device 101, perform cell selection in the order of frequency B, frequency C, and frequency A, based on the updated priority of the frequency list related to cell selection.

According to an embodiment, the electronic device 101 may, in a case that the electronic device 101 corresponds to a fixed sensor (or fixed sensor device) supporting the reduced capability, identify the reduced capability and the power reduction as the feature of the electronic device 101. For example, the processor 200 may update the priorities of frequencies of the frequency list related to cell selection to “B→E→C→D→A”, based on the reduced capability from among features of the electronic device 101. As another example, the processor 200 may, in a case that frequency A in the frequency list related to cell selection does not support the reduced capability, update the priority of frequency A to have the lowest priority. For example, the processor may delete frequency A not supporting the reduced capability from the frequency list related to cell selection. By way of example, the processor 200 may, in a case that the electronic device 101 supports “halfDuplexRedCap,” update frequency C and frequency D not supporting “halfDuplexRedCap” to have a relatively low priority. As another example, the processor may delete frequency C and frequency D not supporting “halfDuplexRedCap” from the frequency list related to cell selection.

In an embodiment, the processor 200 may update the priorities of frequencies of the frequency list related to cell selection to “E→B→C→D→A” based on a power consumption state. By way of example, the processor 200 may update the priority of frequency E supporting a power consumption function to be relatively high.

According to an embodiment, the electronic device 101 may, in a case that the electronic device 101 corresponds to a wearable device (e.g., a watch, glasses, or the like) in a first state supporting the reduced capability, identify the reduced capability, the high transfer rate, and the service area state as the feature of the electronic device 101. For example, the processor 200 may update the priorities of frequencies of the frequency list related to cell selection to “B→C→D→E→A”, based on the reduced capability from among features of the electronic device 101. For example, the processor 200 may, in a case that frequency A in the frequency list related to cell selection does not support the reduced capability, update the priority of frequency A to have the lowest priority. For example, the processor may delete frequency A not supporting the reduced capability from the frequency list related to cell selection.

For example, the processor 200 may update the priorities of frequencies of the frequency list related to cell selection to “C→D→E→B→A” based on the service area state. By way of example, the processor 200 may update the priority of frequency B not supporting “intraFreqReselectionRedCap” to be relatively low. For example, a state of supporting “intraFreqReselectionRedCap” may include a state of being able to support a relatively large service area.

In an embodiment, the processor 200 may update the priorities of frequencies of the frequency list related to cell selection to “E→C→D→B→A” based on a state of the high transfer rate (e.g., eMBB). By way of example, the processor 200 may update the priority of frequency E supporting a highest SCS to the highest.

According to an embodiment, the electronic device 101 may, in a case that the electronic device 101 corresponds to a wearable device (e.g., a watch, glasses, or the like) in a second state supporting the reduced capability, identify the reduced capability, the power reduction, and the service area state as the feature of the electronic device 101. For example, the processor 200 may update the priorities of frequencies of the frequency list related to cell selection to “B→C→D→E→A”, based on the reduced capability from among features of the electronic device 101. As another example, the processor 200 may, in a case that frequency A in the frequency list related to cell selection does not support the reduced capability, update the priority of frequency A to have the lowest priority. As another example, the processor may delete frequency A not supporting the reduced capability from the frequency list related to cell selection.

In an embodiment, the processor 200 may update the priorities of frequencies of the frequency list related to cell selection to “C→D→E→B→A” based on the service area state. By way of example, the processor 200 may update the priority of frequency B not supporting “intraFreqReselectionRedCap” to be relatively low. For example, a state of supporting “intraFreqReselectionRedCap” may include a state of being able to support a relatively large service area.

For example, the processor 200 may update the priorities of frequencies of the frequency list related to cell selection to “C→E→D→B→A” based on a state of the power reduction. By way of example, the processor 200 may update the priority of frequency E supporting a power consumption function to be relatively high.

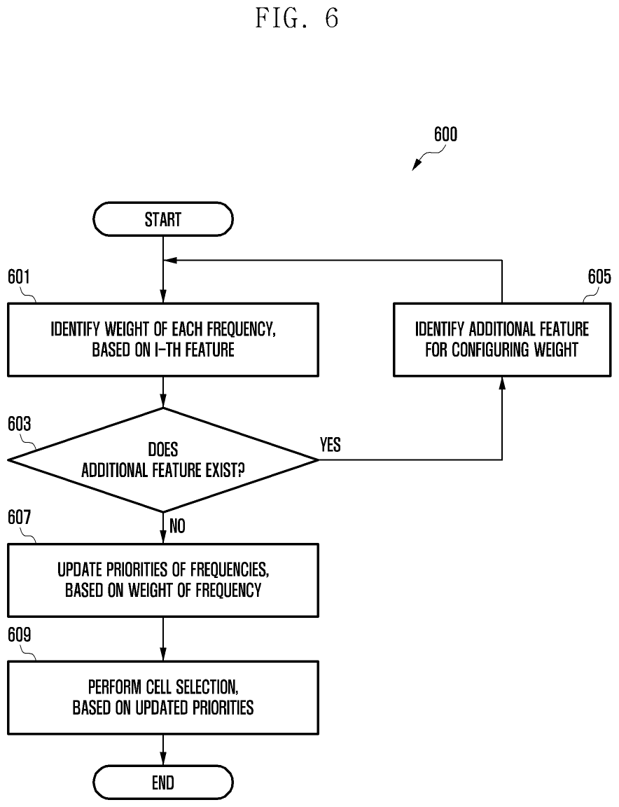

FIG. 6 is a flowchart 600 illustrating updating a priority of a frequency list related to cell selection based on a feature of an electronic device in the electronic device, according to an embodiment. By way of example, at least a portion of FIG. 6 may include a detailed operation of operation 305 and operation 307. In the following embodiment, respective operations may be sequentially performed, but are not necessarily sequentially performed. For example, the sequential position of each operation may be changed, or at least two operations may be performed in parallel. By way of example, the electronic device in FIG. 6 may correspond to the electronic device 101.

According to an embodiment referring to FIG. 6, the electronic device (e.g., the electronic device 101) or the processor (e.g., the processor 120 or the processor 200) may, in a case that the priorities of frequencies included in the frequency list related to cell selection has been configured based on the result of the scan with respect to the frequency list related to cell selection (e.g., operation 303), identify, in operation 601, a weight of each frequency included in the frequency list related to cell selection based on the i-th feature of the electronic device 101. By way of example, the processor 200 may, in a case that the electronic device 101 corresponds to a VR device supporting the reduced capability, identify the reduced capability, the high reliability, the high transfer rate, and the service area as the feature of the electronic device 101.

For example, the processor 200 may identify a weight corresponding to the reduced capability for each frequency included in the frequency list related to cell selection, based on the reduced capability from among features of the electronic device 101. By way of example, the processor 200 may, in a case that the electronic device 101 supports the reduced capability and two (2) receive paths (Rx), configure, by referring to Table 4, a weight of frequency C supporting the reduced capability and one receive path to have a value of “1.” The processor 200 may configure a weight of frequency B, frequency D, and frequency E supporting the reduced capability and two receive paths to have a value of “2.” For example, the processor 200 may configure a weight of frequency A not supporting the reduced capability to have a value of “0.”

TABLE 4

| Classification | Item | Weight |
|---|---|---|
| capability | halfDuplexRedCap-Allowed-r17 (SIB 1) | 0 |
| | cellBarredRedCap1Rx-r17 (SIB 1) | 1 |
| | cellBarredRedCap2Rx-r17 (SIB 1) | 2 |
| | intraFreqReselectionRedCap-r17 (SIB 1) | 0 |
| coverage | intraFreqReselectionRedCap-r17 (SIB 1) | 1 |
| power saving | eDRX-Allowedidle-r17 (SIB1) | 1 |
| | relaxedMeasurement-r16 (SIB 2) | 1 |
| URLLC/eMBB | bandwidth (carrierBandwidth) | 2 |
| | subcarrierspacing (SIB 1) | 0 |
| | configured grant | 0 |
| | PDCP duplication | 0 |

According to an embodiment, the electronic device (e.g., the electronic device 101) or the processor (e.g., the processor 120 or 200) may, in operation 603, identify whether there is an additional feature not used for configuring the weights of frequencies included in the frequency list related to cell selection, from among features of the electronic device 101. For example, the processor 200 may identify whether there is a feature not used for updating the priorities of frequencies included in the frequency list related to cell selection, from among the reduced capability, the high reliability, the high transfer rate, and the service area, corresponding to a VR device (or AR device) supporting the reduced capability.

According to an embodiment, the electronic device (e.g., the electronic device 101) or the processor (e.g., the processor 120 or 200) may, in a case that there is the additional feature not used for configuring the weights of frequencies included in the frequency list related to cell selection (e.g., “Yes” in operation 603), identify, in operation 605, an additional feature to be considered to configure the weights of frequencies included in the frequency list related to cell selection. For example, the processor 200 may identify features of the reduced capability, the high reliability, the high transfer rate, and the service area corresponding to a VR device (or AR device) supporting the reduced capability as the additional feature.

According to an embodiment, the electronic device (e.g., the electronic device 101) or the processor (e.g., the processor 120 or 200) may, in operation 601, configure the weights of frequencies of the frequency list related to cell selection based on the additional feature (e.g., the (i+1)-th feature) of the electronic device 101. By way of example, the processor 200 may configure the weight of frequency E supporting the highest SCS to have a value of “2.”

According to an embodiment, the electronic device (e.g., the electronic device 101) or the processor (e.g., the processor 120 or 200) may repeatedly perform operations 601 to 605 until the weights of the frequencies included in the frequency list related to cell selection are configured by considering all features of the electronic device 101. By way of example, the processor 200 may configured the weight of frequency D supporting “intraFreqReselectionRedCap” to have a value of “1” and the weight of frequency B supporting “intraFreqReselectionRedCap” to have a value of “0.”

According to an embodiment, the electronic device (e.g., the electronic device 101) or the processor (e.g., the processor 120 or 200) may, in a case that there is no additional feature not used for configuring the weights of frequencies included in the frequency list related to cell selection (e.g., “No” in operation 603), update, in operation 607, the priorities of frequencies included in the frequency list related to cell selection, based on the weight configured based on the feature of the electronic device 101. For example, the processor 200 may update the priorities of frequencies of the frequency list related to cell selection to “E→D→B→C→A” based on the weight of each frequency configured based on the feature of the electronic device 101.

According to an embodiment, the electronic device (e.g., the electronic device 101) or the processor (e.g., the processor 120 or 200) may, in operation 609, perform cell selection by using the frequency list related to the cell selection having the updated priority based on a feature of the electronic device 101. By way of example, the processor 200 may control the communication circuit 210 to identify whether there is a cell for camping on by using frequency E having a highest priority in the frequency list which is related to cell selection and of which priority has been updated based on a feature of the electronic device 101. The processor 200 may, in a case of identifying that there is a cell for camping on (or a cell suitable for camping on) by using frequency E, identify (or select) the corresponding cell as a cell to which the electronic device 101 may be connected (or registered). The processor 200 may, in a case of identifying that there is no cell for camping on (or no cell suitable for camping on) by using frequency E, control the communication circuit 210 to identify whether there is a cell for camping on by using a frequency having a next priority D.

According to an embodiment, the electronic device 101 may, in a case that there is no cell using frequency D for camping on of the electronic device 101, perform cell selection in the order of frequency B, frequency C, and frequency A, based on the updated priority of the frequency list related to cell selection.

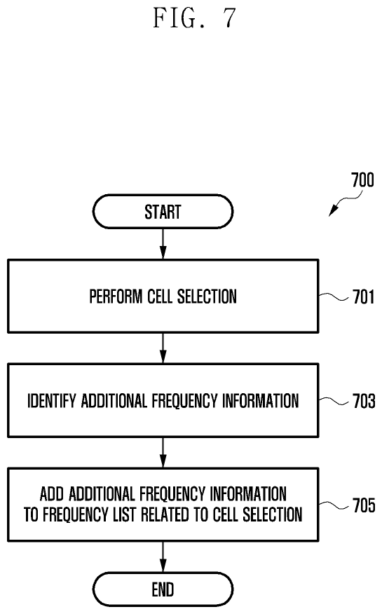

FIG. 7 is a flowchart 700 illustrating adding at least one frequency to a frequency list related to cell selection in an electronic device, according to an embodiment. In the following embodiment, respective operations may be sequentially performed, but are not necessarily sequentially performed. For example, the sequential position of each operation may be changed, or at least two operations may be performed in parallel. By way of example, the electronic device in FIG. 7 may correspond to the electronic device 101.

According to an embodiment referring to FIG. 7, the electronic device (e.g., the electronic device 101) or the processor (e.g., the processor 120 or the processor 200) may perform, in operation 701, cell selection. For example, the processor 200 may, as shown in operations 301 to 307, control the communication circuit 210 to perform cell selection based on the priorities of frequencies included in the frequency list related to cell selection updated based on the feature of the electronic device 101.

According to an embodiment, the electronic device (e.g., the electronic device 101) or the processor (e.g., the processor 120 or 200) may, in operation 703, identify additional frequency information from the cell selected based on the priority updated based on the feature of the electronic device 101. For example, the processor 200 may, in a case that the electronic device 101 supports the reduced capability, identify additional frequency information supporting the reduced capability from “redCapAccessAllowed” of an “interFrequCarrierFreqInfo” field of SIB 4. As another example, the additional frequency information may include information related to a frequency (e.g., an inter frequency) of a neighboring cell different from the cell to which the electronic device 101 may be connected and which is selected using the frequency list related to cell selection.

According to an embodiment, the electronic device (e.g., the electronic device 101) or the processor (e.g., the processor 120 or 200) may, in operation 705, update the frequency list related to cell selection, based on the additional frequency information. For example, the processor 200 may add the additional frequency information to the frequency list related to cell selection. By way of example, the additional frequency information (e.g., frequency F, frequency G, or frequency H) may be added to the frequency list related to cell selection with a relatively low priority as shown in Table 5.

TABLE 5

| Frequency | Cell Parameter |
|---|---|
| A | No intraFreqReselectionRedCap-r17 IE |
| B | All capability is supported |
| | intraFreqReselectionRedCap-r17 IE (not supported) |
| | SCS 30 kHz, BW 50 MHz |
| C | only cellbarredRedCap1Rx-r17 (supported) |
| | intraFreqReselectionRedCap-r17 IE (supported) |
| | SCS 30 kHz, BW 50 MHz |
| | power saving (supported) |
| D | only cellbarredRedCap1Rx/2Rx-r17 (supported) |
| | intraFreqReselectionRedCap-r17 IE (supported) |
| | SCS 30 kHz, BW 50 MHz |
| E | All capability is supported |
| | intraFreqReselectionRedCap-r17 IE (supported) |
| | SCS 120 kHz, BW 100 MHz |
| | power saving (supported) |
| F | SIB 4 redcapaccessallowed-r17 |
| G | SIB 4 redcapaccessallowed-r17 |
| H | SIB 4 redcapaccessallowed-r17 |

According to an embodiment, an operation method of an electronic device (e.g., the electronic device 101) may include an operation of performing a scan related to multiple frequencies included in a frequency list related to cell selection. According to an embodiment, the operation method of the electronic device may include an operation of configuring priorities of the multiple frequencies, based on a result of the scan. According to an embodiment, the operation method of the electronic device may include an operation of updating the priorities of the multiple frequencies included in the frequency list based on at least one feature of the electronic device. According to an embodiment, the operation method of the electronic device may include an operation of performing cell selection, based on the updated priorities of the multiple frequencies included in the frequency list.

According to an embodiment, the operation method of the electronic device may include an operation of identifying at least one feature of the electronic device, based on at least one of an execution history of an application program of the electronic device, an application program running in the electronic device, or a capability of the electronic device.

According to an embodiment, the at least one feature of the electronic device may include at least one of a function related to a reduced capability (RedCap), a power reduction function, a high reliability, a high transfer rate, or a service area.

According to an embodiment, the operation of configuring the priority may include an operation of configuring a relatively high priority for a frequency with relatively high channel state information, based on a result of the scan.

According to an embodiment, the operation of updating the priorities may include an operation of identifying at least one frequency for updating a priority from among the multiple frequencies included in the frequency list based on the result of the scan. According to an embodiment, the operation of updating the priority may include an operation of updating the priority of at least one frequency included in the frequency list based on at least one feature of the electronic device.

According to an embodiment, the operation of updating the priorities may include an operation of sequentially updating, in a case that multiple features of the electronic device are considered, the priorities of the multiple frequencies included in the frequency list, based on respective features of the electronic devices.

According to an embodiment, the operation of updating the priorities may include an operation of configuring weights for the multiple frequencies included in the frequency list, respectively, based on respective features of the electronic device. According to an embodiment, the operation of updating the priorities may include an operation of updating the priorities of the multiple frequencies included in the frequency list, based on a sum of the weights.

According to an embodiment, the operation of performing the cell selection may include an operation of sequentially performing cell selection using each frequency included in the frequency list based on the updated priority.

According to an embodiment, the operation method of the electronic device may include an operation of obtaining additional frequency information based on system information obtained from a cell selected for the cell selection. According to an embodiment, the operation method of the electronic device may include an operation of adding the additional frequency information to the frequency list with a relatively low priority.

According to an embodiment, a non-transitory computer-readable storage medium (or computer program product) configured to store one or more programs are described. According to an embodiment the at least one program may include instructions which, when executed by at least one processor (e.g., the processor 120 or the processor 200) of an electronic device (e.g., the electronic device 101), cause the electronic device to perform an operation of performing a scan related to multiple frequencies included in a frequency list related to cell selection, an operation of configuring priorities of the multiple frequencies, based on a result of the scan, an operation of updating the priorities of the multiple frequencies included in the frequency list based on at least one feature of the electronic device, and an operation of performing cell selection, based on the updated priorities of the multiple frequencies included in the frequency list.

The embodiments of the disclosure described and shown in the specification and the drawings are merely specific examples that have been presented to describe the technical contents of embodiments of the disclosure and help understanding of embodiments of the disclosure, and are not intended to limit the scope of embodiments of the disclosure. Therefore, the scope of an embodiment of the disclosure may be construed to include, in addition to the embodiments set forth herein, all changes and modifications derived based on the technical idea of an embodiment of the disclosure.

What is claimed is:

1. An electronic device, comprising:
communication circuitry;
at least one processor comprising processing circuitry; and
memory storing instructions,
wherein the instructions, when executed by the at least one processor individually or collectively, cause the electronic device to:
perform a scan related to multiple frequencies included in a frequency list related to cell selection;
configure priorities of the multiple frequencies based on a result of the scan;
update the priorities of the multiple frequencies in the frequency list based on at least one feature of the electronic device; and
perform the cell selection based on the updated priorities of the multiple frequencies.

2. The electronic device of claim 1, wherein the instructions, when executed by the at least one processor individually or collectively, further cause the electronic device to:
identify the at least one feature of the electronic device, based on at least one of an execution history of an application program of the electronic device, an application program running in the electronic device, or a capability of the electronic device.

3. The electronic device of claim 1, wherein the at least one feature of the electronic device comprises at least one of a function related to a reduced capability, a power reduction function, a high reliability function, a high transfer rate, or a service area.

4. The electronic device of claim 1, wherein the instructions, when executed by the at least one processor individually or collectively, further cause the electronic device to:
identify at least one frequency from among the multiple frequencies, based on the result of the scan; and
update a priority of the at least one frequency, based on the at least one feature of the electronic device.

5. The electronic device of claim 1, wherein the instructions, when executed by the at least one processor individually or collectively, further cause the electronic device to:
sequentially update the priorities of the multiple frequencies, based on respective multiple features of the electronic device.

6. The electronic device of claim 1, wherein the instructions, when executed by the at least one processor individually or collectively, further cause the electronic device to:
identify respective weights for the multiple frequencies, based on respective features of the electronic device; and
update the priorities of the multiple frequencies based on a sum of the respective weights.

7. The electronic device of claim 1, wherein the instructions, when executed by the at least one processor individually or collectively, further cause the electronic device to:
sequentially perform the cell selection using each frequency of the multiple frequencies based on the updated priorities.

8. The electronic device of claim 7, wherein the instructions, when executed by the at least one processor individually or collectively, further cause the electronic device to:
obtain additional frequency information based on system information obtained from a cell selected for the cell selection; and
add the additional frequency information to the frequency list with a relatively low priority compared to the priorities of the multiple frequencies.

9. An operation method of an electronic device, the operation method comprising:
performing a scan related to multiple frequencies included in a frequency list related to cell selection;
configuring priorities of the multiple frequencies, based on a result of the scan;
updating the priorities of the multiple frequencies in the frequency list, based on at least one feature of the electronic device; and
performing the cell selection, based on the updated priorities of the multiple frequencies.

10. The operation method of claim 9, further comprising:
identifying the at least one feature of the electronic device, based on at least one of an execution history of an application program of the electronic device, an application program running in the electronic device, or a capability of the electronic device.

11. The operation method of claim 9, wherein the at least one feature of the electronic device comprises at least one of a function related to a reduced capability, a power reduction function, a high reliability, a high transfer rate, or a service area.

12. The operation method of claim 9, wherein the updating the priorities comprises:
identifying at least one frequency from among the multiple frequencies, based on the result of the scan; and
updating a priority of the at least one frequency, based on the at least one feature of the electronic device.

13. The operation method of claim 9, wherein the updating the priorities comprises:
sequentially updating the priorities of the multiple frequencies, based on respective multiple features of the electronic device.

14. The operation method of claim 9, wherein the updating the priorities comprises:
identifying respective weights for the multiple frequencies, based on respective features of the electronic device; and
updating the priorities of the multiple frequencies, based on a sum of the respective weights.

15. The operation method of claim 9, wherein the performing the cell selection comprises:
sequentially performing the cell selection using each frequency of the multiple frequencies, based on the updated priorities.

16. The operation method of claim 9, further comprising:
obtaining additional frequency information based on system information obtained from a cell selected for the cell selection; and
adding the additional frequency information to the frequency list with a relatively low priority compared to the priorities of the multiple frequencies.

17. A non-transitory computer-readable storage medium storing computer-executable instructions for operating an electronic device that, when executed by at least one processor of the electronic device, cause the electronic device to:
perform a scan related to multiple frequencies included in a frequency list related to cell selection;
configure priorities of the multiple frequencies in the frequency list based on a result of the scan;
update the priorities of the multiple frequencies based on at least one feature of the electronic device; and
perform the cell selection based on the updated priorities of the multiple frequencies.

18. The non-transitory computer-readable storage medium of claim 17, wherein the computer-executable instructions, when executed by the at least one processor, further cause the electronic device to:
identify the at least one feature of the electronic device, based on at least one of an execution history of an application program of the electronic device, an application program running in the electronic device, or a capability of the electronic device.

19. The non-transitory computer-readable storage medium of claim 17, wherein the computer-executable instructions, when executed by the at least one processor, further cause the electronic device to:
identify at least one frequency from among the multiple frequencies, based on the result of the scan; and
update a priority of the at least one frequency, based on the at least one feature of the electronic device.

20. The non-transitory computer-readable storage medium of claim 17, wherein the computer-executable instructions, when executed by the at least one processor, further cause the electronic device to:
sequentially update the priorities of the multiple frequencies, based on respective multiple features of the electronic device.
